(19) United States
(12) Patent Application Publication
(10) Pub. No.: US 2017/0090709 A1
(43) Pub. Date: Mar. 30, 2017

(54) DISPLAY CONTROL DEVICE AND DISPLAY CONTROL METHOD

(71) Applicant: FUJITSU LIMITED, Kawasaki-shi (JP)

(72) Inventors: Hiroyuki Maekawa, Kawasaki (JP); Takehiko Raku, Zama (JP); Akari Maejima, Kawasaki (JP); Koji Saito, Kawasaki (JP)

(73) Assignee: FUJITSU LIMITED, Kawasaki-shi (JP)

(21) Appl. No.: 15/269,185

(22) Filed: Sep. 19, 2016

(30) Foreign Application Priority Data
Sep. 30, 2015 (JP) 2015-194761

(51) Int. Cl. G06F 3/0486; G06F 3/0481

(52) U.S. Cl. CPC G06F 3/0486; G06F 3/04812; G06F 3/0482

(57) ABSTRACT

A display control method includes: receiving a drag operation on a first window displayed on a display screen, the display screen displaying the first window, a second window, and a third window; and when the drag operation releases the first window on one of a plurality of determination lines, rearranging the first window, the second window, and the third window in a preset display area according to a layout corresponding to the one of the plurality of determination lines, the layout automatically determining a size and a location of the first window so as to display the first window in the preset display area in a non-overlapping manner with respect to the second window and the third window.

### CROSS-REFERENCE TO RELATED APPLICATION

This application is based upon and claims the benefit of priority of the prior Japanese Patent Application No. 2015-194761, filed on Sep. 30, 2015, the entire contents of which are incorporated herein by reference.

### FIELD

The embodiment discussed herein is related to a display control device and a display control method.

### BACKGROUND

In a known drag-and-drop technique, when a user performs a drag-and-drop operation on a window on a display screen, the window is moved to and dropped at a position according to the user operation, and is displayed at the drop position (see, for example, Japanese Laid-open Patent Publication Nos. 2001-325054 and 2006-185025). After moving the window, the user manually makes fine adjustments on the window, such as placing the window at a desired position or resizing the window into a desired size.

In a known technique, when a received drag-and-drop operation on a window specifies switching of windows, a dragged window and a window which is displayed at a position where the dragged window is dropped are switched in their display positions (see, for example, Japanese Laid-open Patent Publication No. 2012-27891).

### SUMMARY

According to an aspect of the invention, a display control method includes: receiving a drag operation on a first window displayed on a display screen, the display screen displaying the first window, a second window, and a third window; and when the drag operation releases the first window on one of a plurality of determination lines, rearranging the first window, the second window, and the third window in a preset display area according to a layout corresponding to the one of the plurality of determination lines, the layout automatically determining a size and a location of the first window so as to display the first window in the preset display area in a non-overlapping manner with respect to the second window and the third window.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the hardware configuration of a display control device according to an embodiment.

FIG. 2 is a diagram illustrating an example of the function and configuration of the display control device according to the embodiment.

FIG. 3 is a diagram illustrating an example of a fitting coordinate table according to the embodiment.

FIG. 4 is a flowchart illustrating an example of display control processing according to the embodiment.

FIG. 5 is a flowchart illustrating an example of fitting processing according to the embodiment.

FIGS. 6A to 6C are diagrams illustrating an example of a display screen according to the embodiment.

FIGS. 7A and 7B are diagrams illustrating an example of a display screen according to the embodiment.

FIGS. 8A and 8B are diagrams illustrating an example of the display screen according to the embodiment.

FIG. 9 is a diagram illustrating an example of the display screen according to the embodiment.

FIG. 10 is a diagram illustrating an example of the display screen according to the embodiment.

FIG. 11 is a diagram illustrating an example of display screen registration according to the embodiment.

FIG. 12 is a diagram illustrating an example of an alternative configuration of the display control device according to the embodiment.

### DESCRIPTION OF EMBODIMENTS

However, when there are multiple windows adjacent to, close to, or overlapping with a target window being operated, it is difficult for the above technique to automatically adjust the multiple windows in conjunction with the operation on the target window.

Thus, an aspect of the technique described in the present disclosure has an object to enable a certain window and two windows to be arranged on a display screen at once in conformity with display areas where the two windows have been displayed, more easily than manually arranging the certain window on the display screen in conformity with the display areas where the two windows have been displayed.

An embodiment is described below with reference to the accompanying drawings. Note that components, herein and in the drawings, having substantially the same function are denoted by the same reference numeral and described only once.

[Hardware Configuration of the Display Control Device]

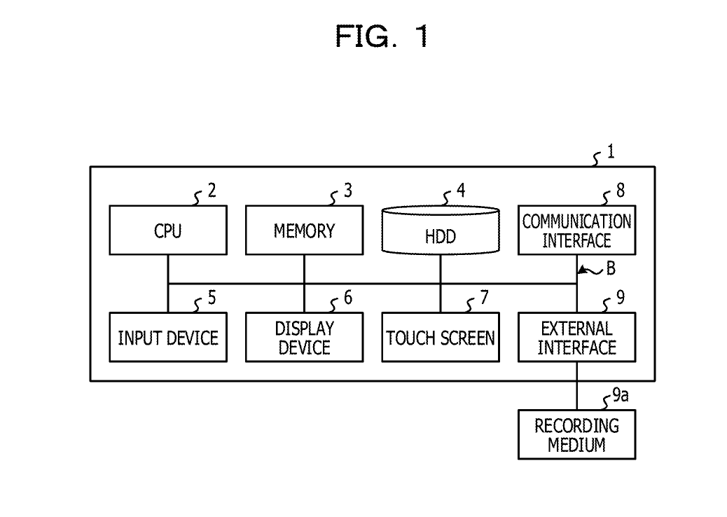

First, an example of the hardware configuration of a display control device 1 according to the present embodiment is described with reference to FIG. 1. The display control device 1 according to the present embodiment is implemented by a personal computer (PC). The display control device 1 is however not limited to this, and may be implemented by a tablet PC, a smartphone, a personal digital assistant (PDA), a mobile phone, a portable music reproduction device, a portable video processing device, a portable video game console, or the like.

The display control device 1 has a central processing unit (CPU) 2, a memory 3, a hard disk drive (HDD) 4, an input device 5, a display device 6, a touch screen 7, a communications interface 8, and an external interface 9. All these parts are connected by buses B.

The memory 3 may be random access memory (RAM) or read-only memory (ROM). RAM is a volatile semiconductor memory capable of retaining programs and data temporarily. ROM is a non-volatile semiconductor memory capable of retaining data even after having been turned off. The RAM or ROM stores programs and data for network settings and the like.

The HDD 4 is a non-volatile recording device and may store programs and data. The programs and data stored in the HDD 4 include control programs for overall control of the display control device 1 and application programs. The control programs include a display control program executed by the CPU 2 or a hardware processor in the present embodiment.

The CPU 2 or the hardware processor performs overall control of the display control device 1 or implements a display control function installed in the display control device 1, by reading the control programs and data from the HDD 4, saving the control programs and data in the memory 3, and executing predetermined processing based on the control programs and data.

The input device 5 includes, for example, a keyboard or a mouse, and inputs a drag-and-drop operation according to user operation. The display device 6 includes a display and is capable of displaying multiple windows on a display screen at once. The touch screen 7 is layered on the display screen of the display device 6 and detects a touch operation by the user. The touch screen 7 detects when an operation object, such as a finger of the user, touches the touch screen 7. Thus, the display device 6 functions also as an input device. The display device 6 may be without the touch screen 7.

The communications interface 8 is an interface used to connect the display control device 1 to a network. The communications interface 8 allows the display control device 1 to perform data communications with another device.

The external interface 9 is an interface used to connect the display control device 1 to an external device. The external device is, for example, a recording medium 9a. The external interface 9 allows the display control device 1 to read data from the recording medium 9a and/or write data to the recording medium 9a. Examples of the recording medium 9a include a compact disk (CD), a digital versatile disk (DVD), a Secure Digital (SD) memory card, and a Universal Serial Bus (USB) memory.

[Function and Configuration of the Display Control Device]

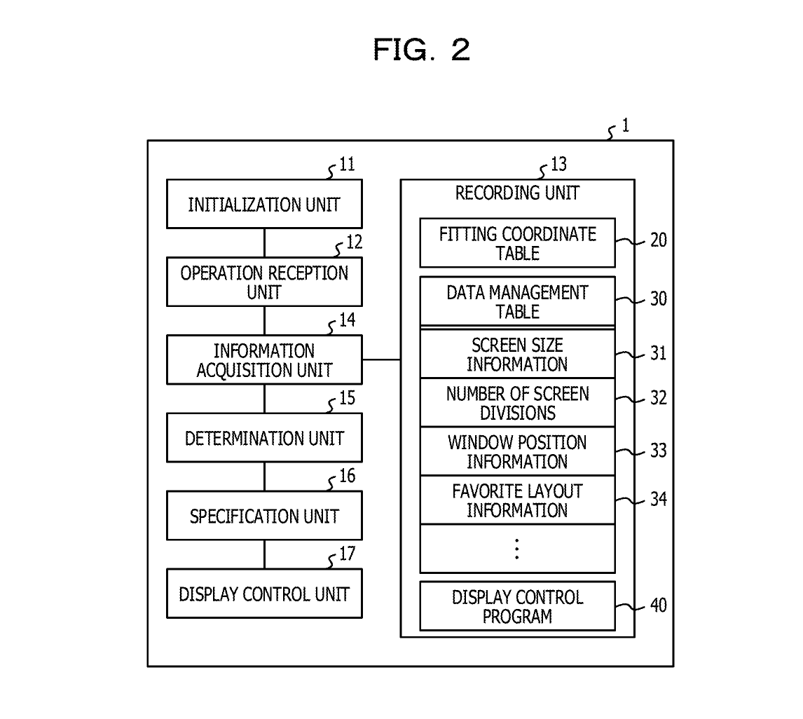

Next, an example of the function and configuration of the display control device 1 according to the present embodiment is described with reference to FIG. 2. The display control device 1 has an initialization unit 11, an operation reception unit 12, a recording unit 13, an information acquisition unit 14, a determination unit 15, a specification unit 16, and a display control unit 17.

The initialization unit 11 initializes a fitting coordinate table 20. The operation reception unit 12 receives a user operation performed on a window displayed on the display screen. The operation reception unit 12 receives a drag operation on a window and then starts monitoring the position (coordinates) of the window which changes as the window moves. The operation reception unit 12 also receives a drop operation on the monitored window, separately from the drag operation. The operation reception unit 12 detects the coordinates of the window when the window is dropped. When the detected coordinates are particular coordinates (e.g., on a determination line to be described later), the display control unit 17 displays, according to a predetermined layout corresponding to the determination line, the window being operated and two adjacent windows whose border is identifiable based on the determination line. Known methods are used to detect the drag-and-drop operations on the window and to control the position and size of the window. Thus, detailed descriptions for such methods are omitted herein.

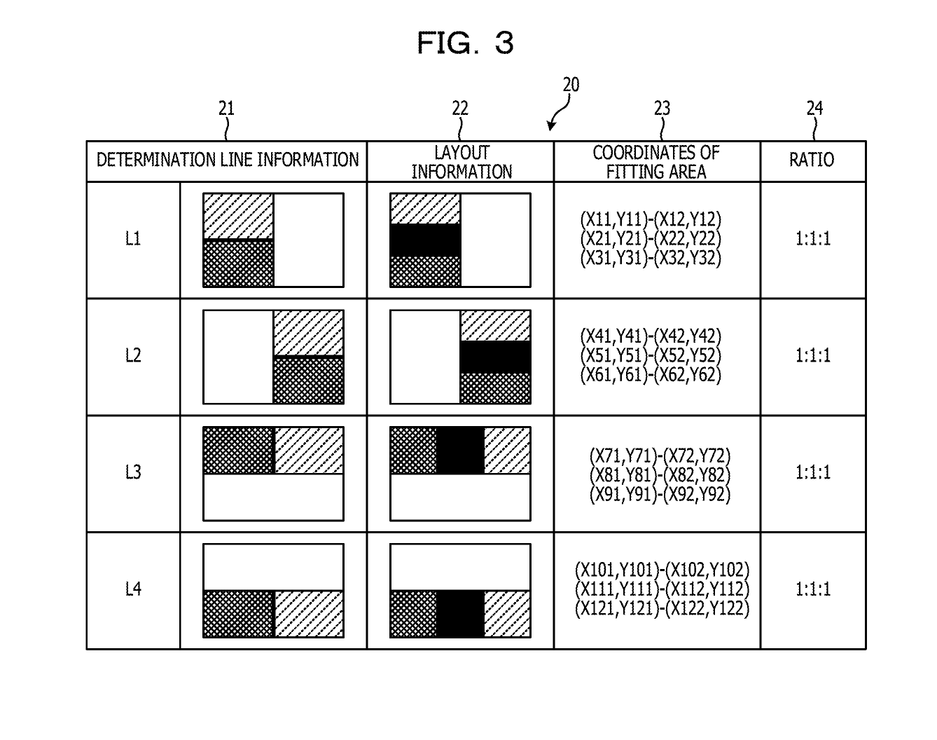

The recording unit 13 records the fitting coordinate table 20, a data management table 30, a display control program 40, and other control programs and various pieces of data. Layouts of the certain window and the two windows are recorded in the fitting coordinate table 20 beforehand, each layout arranging the certain window in association with the two windows according to an operation received by the operation reception unit 12. FIG. 3 illustrates an example of the fitting coordinate table 20 according to the embodiment.

The fitting coordinate table 20 has the following data items: determination line information 21, layout information 22, coordinates of fitting area 23, and ratio 24. The determination line information 21 indicates the name of a determination line and a mark to be displayed on the display screen, the mark indicating the position of the determination line. The determination line is an example of a guide image which guides an operation for selecting a certain window to be displayed in association with two adjacent, close, opposing, or overlapping windows displayed on the display screen. In the present embodiment, the guide image is a linear image located at, e.g., the border of two windows. The embodiment is however not limited to this. For example, the guide image may be the mark of the determination line information 21 displayed between two windows. The guide image does not necessarily have to be displayed.

The layout information 22 indicates information on a layout (arrangement) of three windows: the certain window and the two adjacent windows. The coordinates of fitting area 23 indicates display positions of the respective three windows. The display areas of the three windows specified by the coordinates of fitting area 23 are set so as not to overlap one another. For example, when a window is dropped on the determination line “L1”, the three windows are arranged and displayed vertically on the left half of the screen based on the layout information 22. The window dropped on the determination line L1 (also referred to as an “operated window” hereinbelow) is arranged between the adjacent windows. Among the coordinate sets indicated by the coordinates of fitting area 23, the operated window is displayed on an area specified by (X21,Y21)-(X22,Y22). The adjacent windows displayed adjacently on both sides of the operated window are displayed on areas specified by (X11,Y11)-(X12-Y12) and (X31,Y31)-(X32-Y32), respectively. These three windows are displayed in the same size, i.e., the ratio of their display areas is (1:1:1). Thus, the operated window is resized to be displayed in the one-third center area of the left half of the screen. Similarly, the adjacent windows are resized to be displayed in the one-third upper area and the one-third lower area of the left half of the screen, respectively.

The marks of the determination line information 21 and the layout information 22 do not necessarily have to be recorded in the fitting coordinate table 20. If the ratio 24 does not vary and is a predetermined fixed value, the ratio 24 does not necessarily have to be recorded in the fitting coordinate table 20, either.

Referring back to FIG. 2, the data management table 30 has screen size information 31 on the display device 6, number of screen divisions 32, window position information 33, and favorite layout information 34. The information acquisition unit 14 acquires, for example the screen size information 31, the number of screen divisions 32, the window position information 33, and the favorite layout information 34. The window position information 33 indicates the coordinates of the dragged window before the drag.

The determination unit 15 determines, based on an operation received by the operation reception unit 12, whether a certain window has been selected to be displayed in association with adjacent windows. When it is determined based on an operation received by the operation reception unit 12 that a certain window has been selected to be displayed in association with adjacent windows, the specification unit 16 refers to the fitting coordinate table 20 and specifies a layout for displaying the adjacent windows and the certain window.

According to the layout thus specified, the display control unit 17 displays the adjacent windows and the certain window within the areas where the adjacent windows have been displayed. The display control unit 17 displays the three windows within the areas where the adjacent windows have been displayed, by inserting the certain window, dropped at the position of the determination line, between the adjacent windows.

With this configuration, the CPU 2 or the hardware processor of the display control device 1 according to the present embodiment executes display control processing, to be described later, using the display control program 40 stored in the memory 3 or the like. The display control program 40 according to the present embodiment may be a resident program which is resident in the memory 3 while the OS of the display control device 1 is running. When the user performs a drag-and-drop operation while the display control device 1 is executing a certain application, an interrupt occurs. In response to the interrupt by the drag-and-drop operation, the CPU 2 or the hardware processor executes the display control processing in accordance with the procedures indicated by the display control program 40.

The information recorded in the fitting coordinate table 20 illustrated in FIG. 3 and in the data management table 30 may be recorded in the memory 3 or the HDD 4, or may alternatively be stored in, for example, a cloud server connected to the display control device 1 via a network.

[Display Control Processing]

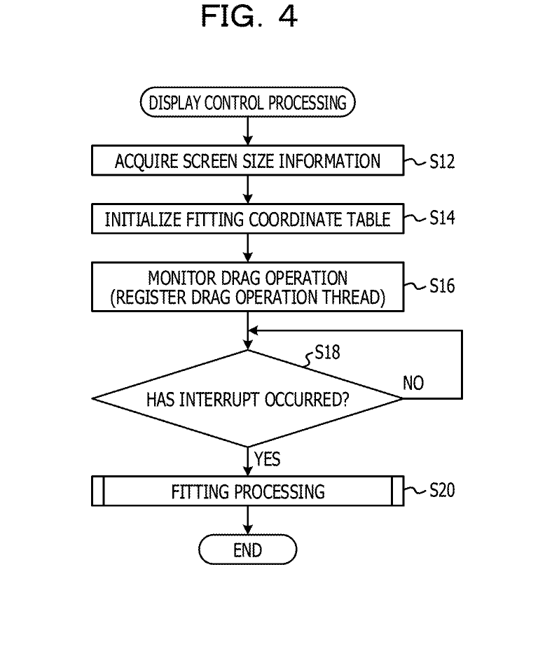

Next, an example of the display control processing according to the present embodiment is described with reference to FIG. 4. Once the display control processing is started, the information acquisition unit 14 acquires screen size information (Step S12). The recording unit 13 records the acquired screen size information in the screen size information 31 of the data management table 30.

Next, the initialization unit 11 initializes the fitting coordinate table 20 (Step S14). The initialization unit 11 divides the display screen based on the acquired screen size information and sets, for each determination line information 21, the coordinates of fitting area 23 defining one of the divided display areas.

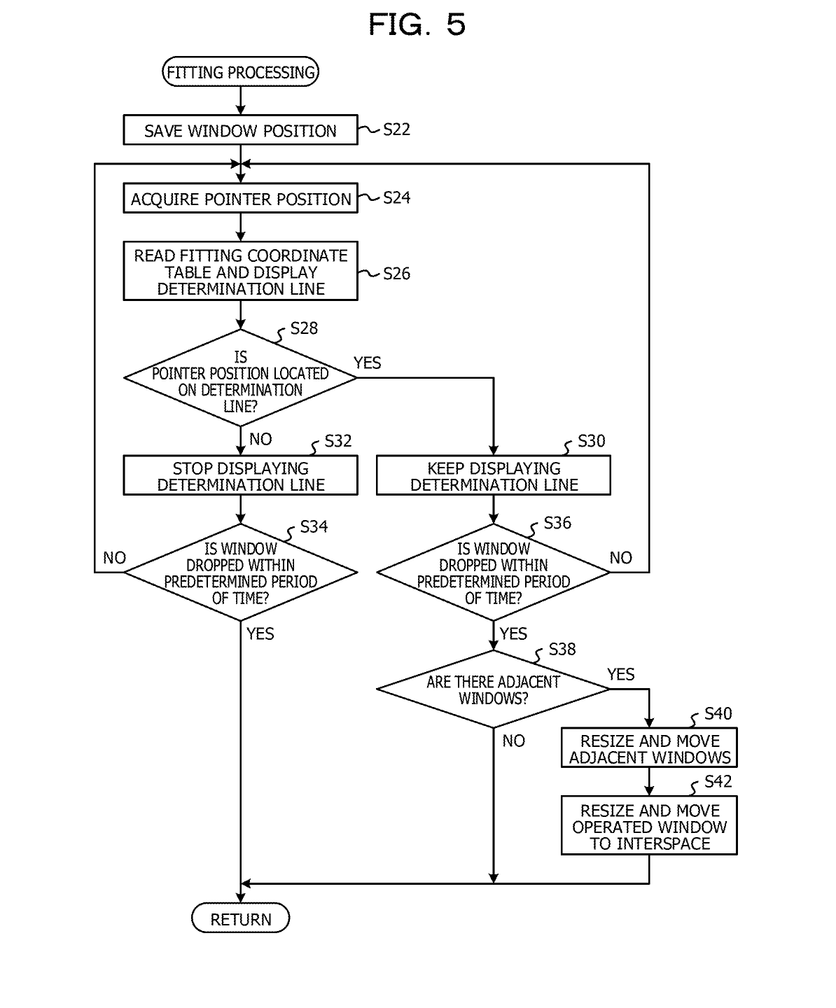

Next, the operation reception unit 12 registers a drag operation thread, and starts monitoring a drag operation by the user (Step S16). The determination unit 15 determines whether an interrupt by a drag operation has occurred (Step S18). When the user performs a drag operation, an interrupt occurs for the drag operation thread for executing fitting processing according to the drag operation event. When the determination unit 15 determines that an interrupt has occurred, the fitting processing is performed (Step S20, FIG. 5), and this display control processing ends.

[Fitting Processing]

Once the fitting processing in FIG. 5 is started, the information acquisition unit 14 acquires the coordinates of the pre-drag display position of the window on which the drag operation is being performed (Step S22). The recording unit 13 records the acquired coordinates of the display position of the window in the window position information 33 of the data management table 30.

Next, the information acquisition unit 14 acquires the position of a pointer moved by the drag operation (Step S24). In the present embodiment, the position of the pointer is the position of a cursor. However, the embodiment is not limited to this. The position of the pointer may be a position on the touch screen 7 touched or approached by a finger of the user.

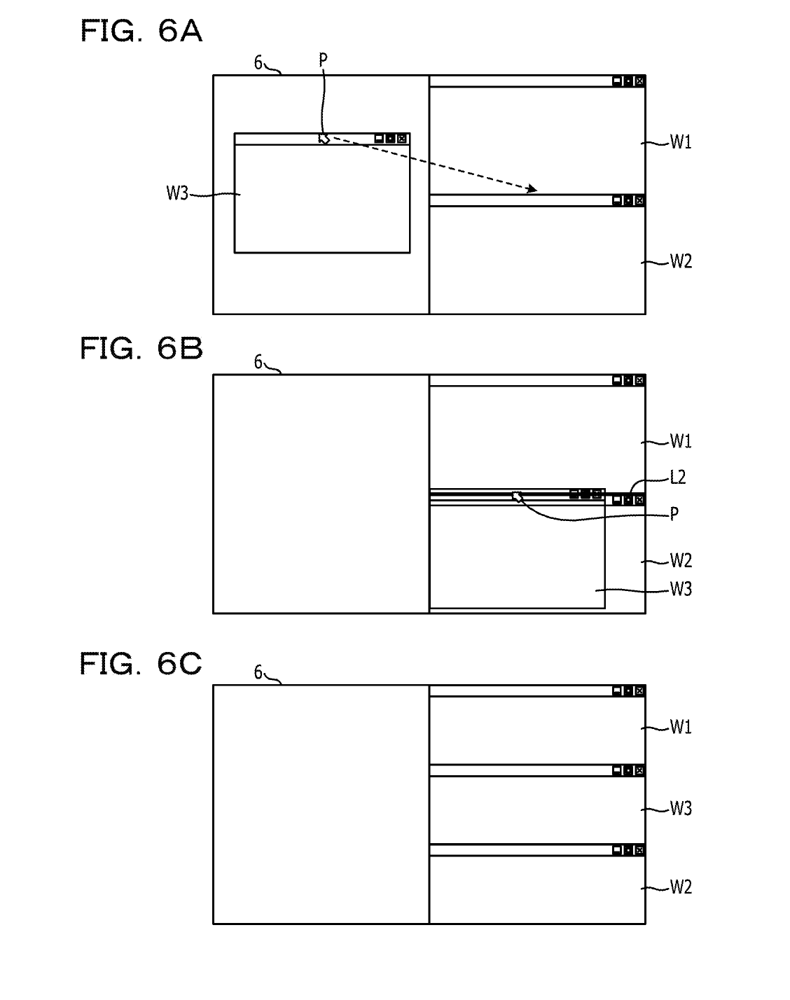

Next, the display control unit 17 reads the fitting coordinate table 20 and displays a determination line according to the position of the pointer (Step S26). For example, in FIG. 6A, a window W3 displayed on the display screen is being dragged and is therefore active. In this state, the user moves a pointer P to the upper right of the screen. During this pointer moving operation, in the example in FIG. 6B, a determination line L2 is being displayed according to the moving direction of the window W3.

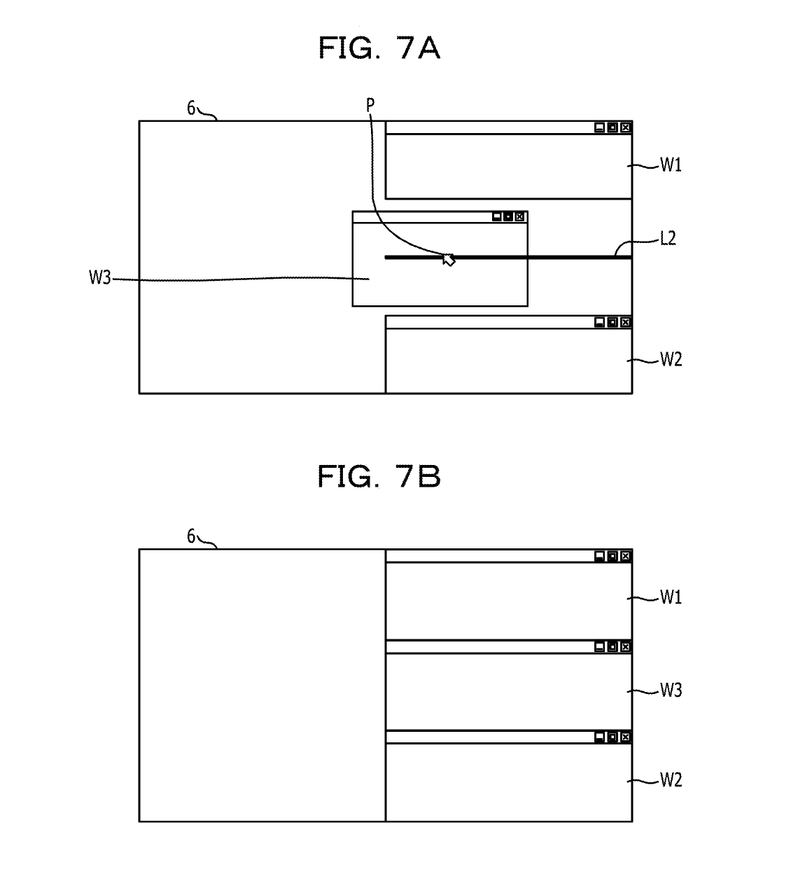

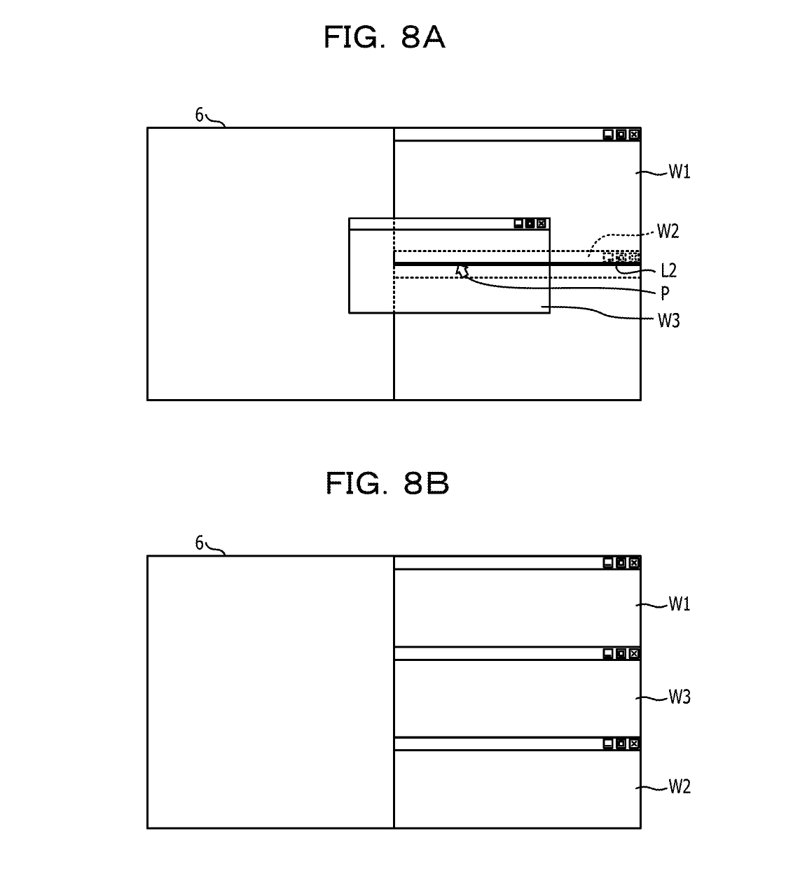

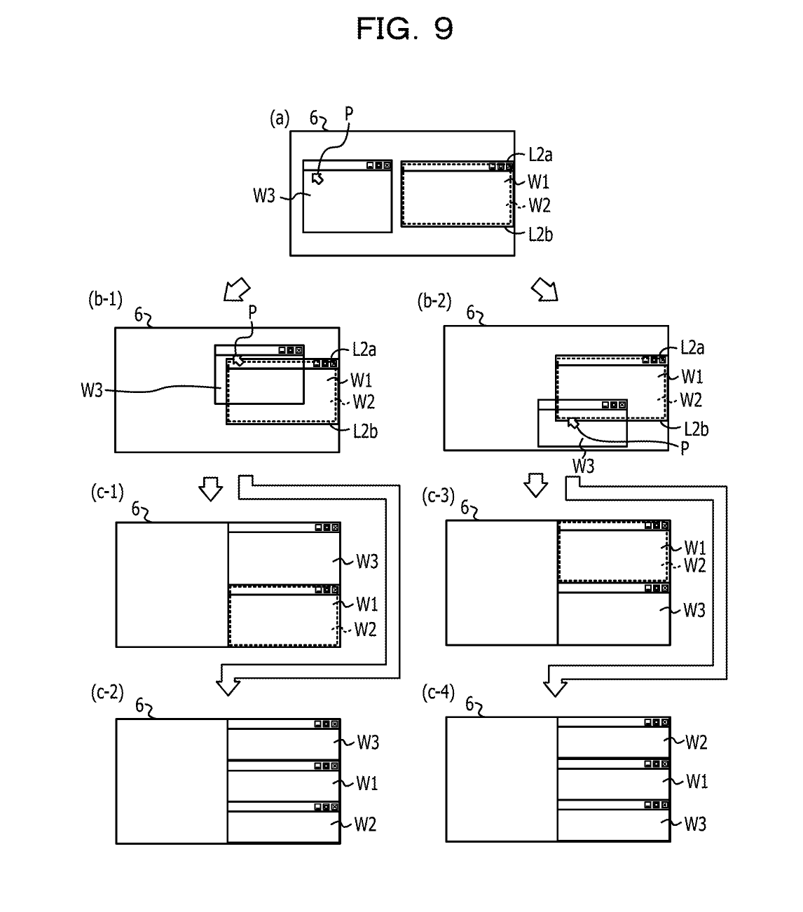

A method of displaying the determination line is, however, not limited to this. For example, without taking the moving direction of the pointer P into consideration, the display control unit 17 may display all the determination lines indicated by the determination line information 21 in the fitting coordinate table 20 illustrated in FIG. 3. The display control unit 17 may display the determination line L2 illustrated in FIG. 6B at a position where two windows W1, W2 are adjacent to each other as illustrated in FIG. 6A. When the two windows W1, W2 are close to each other, the determination line L2 may be displayed at a position where they are close to each other. As illustrated in FIG. 7A, when the two windows W1, W2 are distanced from each other, the display control unit 17 may display the determination line L2 at a position across which the windows W1, W2 face each other. As illustrated in FIG. 8A, when the two windows W1, W2 overlap each other partially, the display control unit 17 may display the determination line L2 at the overlap position. As illustrated in (a) of FIG. 9, when the two windows W1, W2 overlap each other entirely, the display control unit 17 may display the determination line L2 on the windows W1, W2.

The display color or outline of the determination line may darken as the pointer P approaches the determination line and pales as the pointer P moves away from the determination line, or vice versa.

The coordinates of fitting area 23 in the fitting coordinate table 20 do not have to correspond one-to-one to the determination line information 21. For example, the coordinates of fitting area 23 may vary depending on whether the pointer P is located on the center of the determination line, the pointer P is located on the right side of the determination line, or the pointer P is located on the left side of the determination line.

Referring back to FIG. 5, next, the determination unit 15 determines whether the pointer P is located on the determination line (Step S28). When it is determined that the pointer P is located on the determination line, the display control unit 17 keeps displaying the determination line (Step S30). When it is determined that the pointer P is not located on the determination line, the display control unit 17 stops displaying the determination line (Step S32). Although the determination line disappears from the screen when the pointer P moves away from the determination line in the present embodiment, the display control unit 17 may keep displaying the determination line even after the pointer P moves away from the determination line, or does not have to display the determination line on the screen at all.

Next, the determination unit 15 determines whether the window W3 has been dropped within a predetermined period of time (Step S34). When it is determined that the window W3 has not been dropped within the predetermined period of time, the fitting processing proceeds back to Step S24 in which the information acquisition unit 14 acquires the current position of the pointer P, and repeats the steps after Step S24. When it is determined that the window W3 has been dropped within the predetermined period of time, the fitting processing ends. In this case, the window W3 is displayed at its dropped position with its size unchanged.

Meanwhile, after the determination line is kept displaying in Step S30, the determination unit 15 determines whether the window W3 has been dropped within a predetermined period of time since the display of the determination line (Step S36). When it is determined that the window W3 has not been dropped within the predetermined period of time, the fitting processing proceeds back to Step S24 in which the information acquisition unit 14 acquires the current position of the pointer P, and repeats the steps after Step S24. When it is determined in Step S36 that the window W3 has been dropped within the predetermined period of time, the determination unit 15 determines that a certain window has been selected to be displayed in association with two windows. Then, the determination unit 15 determines whether there are two windows adjacent to each other (adjacent windows) close to the certain window (Step S38). When it is determined that there are no adjacent windows, the fitting processing ends. In this case, the window W3 is displayed at its drop position with its size unchanged.

Meanwhile, when it is determined that there are adjacent windows, the display control unit 17 displays the adjacent windows, based on the fitting coordinate table 20, after moving and resizing them to fit the fitting areas on which they are to be displayed (Step S40). Next, the display control unit 17 moves and displays the dropped window in an interspace between the adjacent windows after resizing the dropped window to fit its fitting area (Step S42). The fitting processing thus ends.

To be more specific, in Step S40, the specification unit 16 specifies fitting areas corresponding to the determination line on which the pointer P is located, the specification being made based on the coordinates of fitting area 23 in the fitting coordinate table 20.

For example, when the window W3 moves in the lower right direction to follow the movement of the pointer P as illustrated in FIG. 6A, the display control unit 17 displays the determination line L2 as illustrated in FIG. 6B. Then, when the pointer P is placed on the determination line L2, the specification unit 16 specifies, in the fitting coordinate table 20, the coordinates of fitting area 23 corresponding to the determination line information 21 “L2”.

In the present embodiment, when the window W3 illustrated in FIG. 6B is dropped over the determination line L2 with the adjacent windows W1, W2 being present, the display control unit 17 displays the adjacent window W1 after moving the window W1 to a fitting area defined by (X41,Y41)-(X42,Y42) based on the coordinates of fitting area 23 and resizing the window W1 to fit this fitting area. In addition, the display control unit 17 displays the adjacent window W2 after moving the window W2 to a fitting area defined by (X61,Y61)-(X62,Y62) based on the coordinates of fitting area 23 and resizing the window W2 to fit this fitting area.

The display control unit 17 also displays the dropped window W3 after moving the window W3 to a fitting area defined by (X51,Y51)-(X52,Y52) based on the coordinates of fitting area 23 and resizing the window W3 to fit this fitting area. Thereby, as illustrated in FIG. 6C, the window W3 dragged by the user and the adjacent windows W1, W2 are displayed at their display positions according to a particular layout after being resized to fit their respective fitting areas.

Thus, an operated window and adjacent windows may be arranged at once in conformity with the areas where the adjacent windows have been displayed, more easily than when the operated window is manually inserted between the adjacent windows in conformity with the areas where the adjacent windows have been displayed.

In FIGS. 6A to 6C, the operated window W3 is inserted between the adjacent windows W1, W2 so that the three windows W1 to W3 may be arranged adjacent to one another. It is also possible for the display control method according to the present embodiment to insert the operated window W3 between the two windows W1, W2 which are close or opposite to each other so that the three windows W1 to W3 may be arranged adjacent to one another.

For example, as illustrated in FIG. 7A, the display control unit 17 displays the determination line L2 in an interspace between the two opposing windows W1, W2. The pointer P moving the window W3 by a drag operation is placed over the determination line L2, and the window W3 is dropped there. In response to this, as illustrated in FIG. 7B, the display control unit 17 displays the window W3 and the adjacent windows W1, W2 adjacently based on the coordinates of fitting area 23 corresponding to the determination line information 21 “L2”.

It is also possible for the display control method according to the present embodiment to arrange the three windows W1 to W3 adjacently by inserting the operated window W3 between the two windows W1, W2 which partially or entirely overlap each other. For example, as illustrated in FIG. 8A, the display control unit 17 displays the determination line L2 on an overlap between the two partially overlapping windows W1, W2. The pointer P moving the window W3 is placed over the determination line L2, and the window W3 is dropped there. In response to this, as illustrated in FIG. 8B, the display control unit 17 displays the window W3 and the adjacent windows W1, W2 adjacently based on the coordinates of fitting area 23 corresponding to the determination line information 21 “L2”.

For example, as illustrated in (a) of FIG. 9, the display control unit 17 displays a determination line L2a and a determination line L2b on the upper side and the lower side, respectively, of the two entirely-overlapping windows W1, W2. In (b-1) of FIG. 9, the pointer P moving the window W3 is placed over the determination line L2a. When the window W3 is dropped here, as illustrated in (c-1) of FIG. 9, the display control unit 17 may display the window W3 adjacent to the overlapping windows W1, W2 on the side where the determination line L2a is displayed. Alternatively, as illustrated in (c-2) of FIG. 9, the display control unit 17 may adjacently display the three windows W3, W1, W2 with the windows W1, W2 not overlapping each other and the window W3 being adjacent to the window W1 on the side where the determination line L2a is displayed.

Similarly, in (b-2) of FIG. 9, the pointer P moving the window W3 is located on the determination line L2b. When the window W3 is dropped in this state, as illustrated in (c-3) of FIG. 9, the display control unit 17 may display the window W3 adjacent to the overlapping windows W1, W2 on the side where the determination line L2b is displayed. Alternatively, as illustrated in (c-4) of FIG. 9, the display control unit 17 may adjacently display the three windows W3, W1, W2 with the windows W1, W2 not overlapping each other and the window W3 being adjacent to the window W1 on the side where the determination line L2b is displayed.

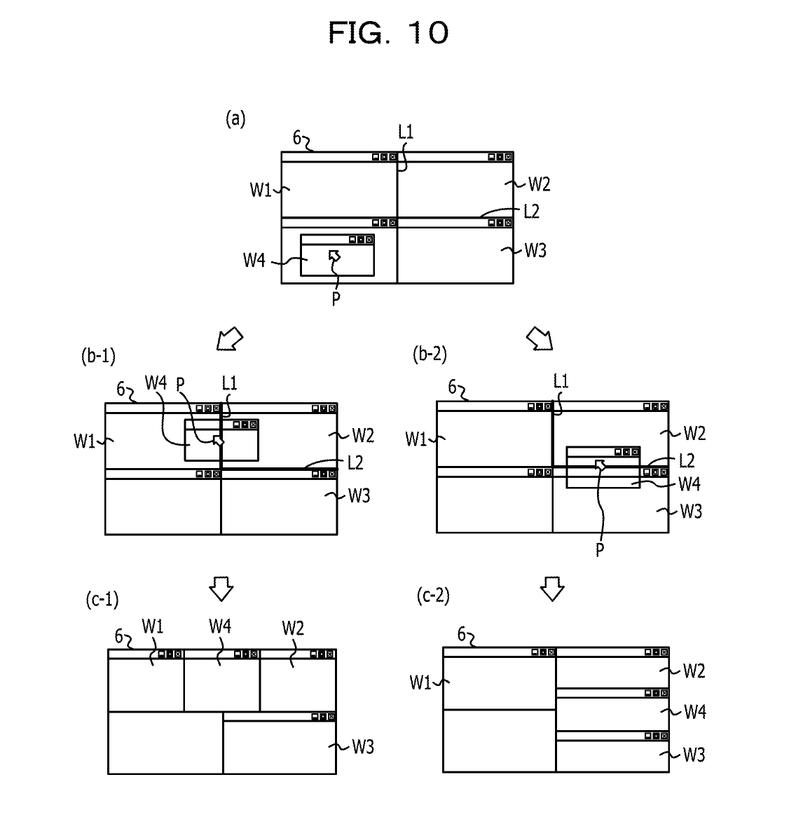

In (a) of FIG. 10, a window W1, a window W2, and a window W3 are displayed in the upper left quarter, the upper right quarter, and the lower right quarter of the screen, respectively. A window W4 moves, by a drag operation, to follow the movement of the pointer P. In this event, in (a) of FIG. 10, a determination line L1 is displayed on the border between the adjacent windows W1, W2, and a determination line L2 is displayed on the border between the adjacent windows W2, W3.

In an example illustrated in (b-1) of FIG. 10, the pointer P moves over the determination line L1, and the window W4 is dropped there. Then, as illustrated in (c-1) of FIG. 10, the window W4 is displayed between the windows W1, W2 adjacently in conformity with the areas where the adjacent windows W1, W2 have been displayed. Thereby, the operated window W4 and the two windows W1, W2 may be adjacently arranged at once in the areas where the windows W1, W2 have been displayed, more easily than when the operated window W4 is manually arranged between the two windows W1, W2 adjacently.

In addition, in an example illustrated in (b-2) of FIG. 10, the pointer P moves over the determination line L2, and the window W4 is dropped there. Then, as illustrated in (c-2) of FIG. 10, the window W4 is displayed between the windows W2, W3 adjacently in conformity with the areas where the adjacent windows W2, W3 have been displayed. Thereby, the operated window W4 and the two windows W2, W3 may be adjacently arranged at once in the areas where the windows W2, W3 have been displayed, more easily than when the operated window W4 is manually arranged between the two windows W2, W3 adjacently.

As described above, the display control method according to the present embodiment allows a certain window to be displayed between two windows which are already displayed. This is achieved more easily than displaying the three windows by manually changing their positions and sizes, and without changing other display properties of the two windows.

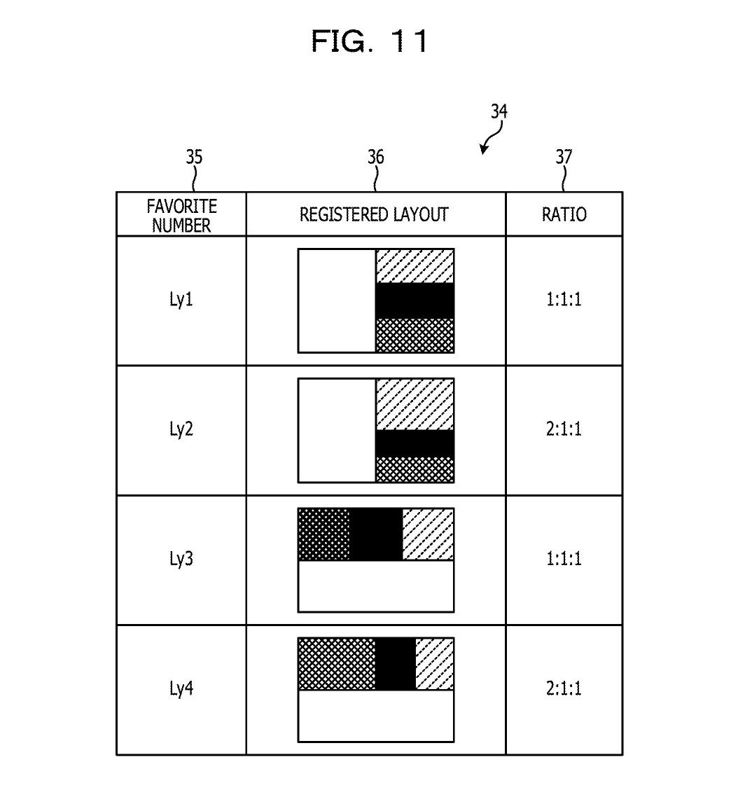

The recording unit 13 may register the favorite layout information 34 in the data management table 30. As illustrated in FIG. 11, the favorite layout information 34 may have the following data items: favorite number 35, registered layout 36, and ratio 37. Based on the registered layout 36 specified by the favorite number 35, multiple windows may be displayed after being resized and rearranged according to a specified favorite layout. For example, the multiple windows may be displayed according to a preset layout in the registered layout 36 specified by the favorite number 35.

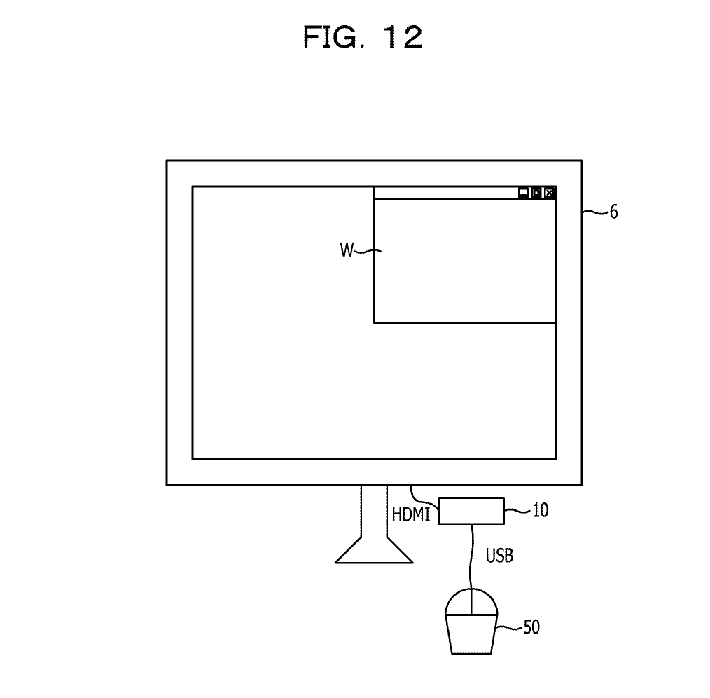

Although the display control device 1 is integral with the display device 6 in the present embodiment, the embodiment is not limited to this. For example, a display control device 10 according to the present embodiment may be configured separately from the display device 6, as illustrated in FIG. 12. Examples of the display control device 10 include a stick computer (a mouse computer).

For example, the display control device 10 is connected to the display device 6 by plugging a High-Definition Multimedia Interface (HDMI (registered trademark)) connector of the display control device 10 into an HDMI port of the display device 6. Examples of the display device 6 include a television, a display, and a projector. An input device such as a mouse 50 may be connected to a USB port of the display control device 10. The mouse 50 is used to allow the window W displayed on the display device 6 to move.

The display control device, the display control method, and the display control program have been described above through the embodiment. However, the display control device, the display control method, and the display control program according to the present disclosure are not limited to the ones described in the embodiment, and may be modified and improved variously without departing from the present disclosure. If there are more than one embodiment and modification, they may be combined as long as contradiction does not occur.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A display control method executed by a computer, the display control method comprising:
receiving a drag operation on a first window displayed on a display screen, the display screen displaying the first window, a second window, and a third window; and
when the drag operation releases the first window on one of a plurality of determination lines, rearranging the first window, the second window, and the third window in a preset display area according to a layout corresponding to the one of the plurality of determination lines, the layout automatically determining a size and a location of the first window so as to display the first window in the preset display area in a non-overlapping manner with respect to the second window and the third window.

2. The display control method according to claim 1, wherein the preset display area is one of (i) a right half of a first line halving the display screen horizontally, (ii) a left half of the first line, (iii) an upper half of a second line halving the display screen vertically, and (iv) a lower half of the second line.

3. The display control method according to claim 2, further comprising:
displaying a first determination line from among the plurality of determination lines,
wherein the first determination line indicates the right half of the first line halving the display screen horizontally, and
the first window, the second window, and the third window are displayed in respective three areas obtained by dividing a right half of the display screen into the three areas when the drag operation releases the first window on the first determination line.

4. The display control method according to claim 2, further comprising:
displaying a second determination line from among the plurality of determination lines,
wherein the second determination line indicates the left half of the first line halving the display screen horizontally, and
the first window, the second window, and the third window are displayed in respective three areas obtained by dividing a left half of the display screen into the three areas when the drag operation releases the first window on the second determination line.

5. The display control method according to claim 2, further comprising:
displaying a third determination line from among the plurality of determination lines,
wherein the third determination line indicates the upper half of the second line halving the display screen vertically, and
the first window, the second window, and the third window are displayed in respective three areas obtained by dividing an upper half of the display screen into the three areas when the drag operation releases the first window on the third determination line.

6. The display control method according to claim 2, further comprising:
displaying a fourth determination line from among the plurality of determination lines,
wherein the fourth determination line indicates the lower half of the second line, and
the first window, the second window, and the third window are displayed in respective three areas obtained by dividing a lower half of the display screen into the three areas when the drag operation releases the first window on the fourth determination line.

7. The display control method according to claim 1, wherein the first window is inserted between the second window and the third window according to the layout.

8. The display control method according to claim 1, further comprising:
displaying a pointer during the drag operation;
when the pointer is located on the one of the plurality of determination lines before the drag operation releases the first window, displaying a guide image on the display screen, the guide image indicating the determination line; and
when the pointer moves away from the one of the plurality of determination lines before the drag operation release the first window, stopping the displaying of the guide image.

9. The display control method according to claim 1, further comprising:
when the first window is placed on the one of the plurality of determination lines, determining whether the second window and the third window is adjacent to each other; and
when the second window and the third window is adjacent to each other, determining a size and a location of the second window and the third window so as to display the second window and the third window in the non-overlapping manner with respect to the first window according to the layout.

10. A display control device comprising:
a memory; and
a processor coupled to the memory and configured to:
receive a drag operation on a first window displayed on a display screen, the display screen displaying the first window, a second window, and a third window, and
when the drag operation releases the first window on one of a plurality of determination lines, rearrange the first window, the second window, and the third window in a preset display area according to a layout corresponding to the one of the plurality of determination lines, the layout automatically determining a size and a location of the first window so as to display the first window in the preset display area in a non-overlapping manner with respect to the second window and the third window.

11. The display control device according to claim 10, wherein the processor is further configured to:
display a pointer during the drag operation,
when the pointer is located on the one of the plurality of determination lines before the drag operation releases the first window, display a guide image on the display screen, the guide image indicating the determination line, and
when the pointer moves away from the one of the plurality of determination lines before the drag operation release the first window, stop the displaying of the guide image.

12. The display control device according to claim 10, wherein the processor is further configured to:
when the first window is placed on the one of the plurality of determination lines, determine whether the second window and the third window is adjacent to each other, and
when the second window and the third window is adjacent to each other, determine a size and a location of the second window and the third window so as to display the second window and the third window in the non-overlapping manner with respect to the first window according to the layout.

13. The display control device according to claim 10, wherein the first window is inserted between the second window and the third window according to the layout.

14. A display control device comprising:
an operation reception unit configured to receive a drag operation on a first window displayed on a display screen, the display screen displaying the first window, a second window, and a third window;
a determination unit configured to determine whether the drag operation releases the first window on one of a plurality of determination lines associated; and
a display control unit configured to rearrange the first window, the second window, and the third window in a preset display area according to a layout corresponding to the one of the plurality of determination lines, the layout automatically determining a size and a location of the first window so as to display the first window in the preset display area in a non-overlapping manner with respect to the second window and the third window.

15. A non-transitory computer readable medium storing a computer-executable program causing a computer to execute a process, the process comprising:
receiving a drag operation on a first window displayed on a display screen, the display screen displaying the first window, a second window, and a third window; and
when the drag operation releases the first window on one of a plurality of determination lines, rearranging the first window, the second window, and the third window in a preset display area according to a layout corresponding to the one of the plurality of determination lines, the layout automatically determining a size and a location of the first window so as to display the first window in the preset display area in a non-overlapping manner with respect to the second window and the third window.

16. The non-transitory computer readable medium according to claim 15, wherein the preset display area is one of (i) a right half of a first line halving the display screen horizontally, (ii) a left half of the first line, (iii) an upper half of a second line halving the display screen vertically, and (iv) a lower half of the second line.

17. The non-transitory computer readable medium according to claim 15, wherein the first window is inserted between the second window and the third window according to the layout.

18. The non-transitory computer readable medium according to claim 15, the process further comprising:
displaying a pointer during the drag operation;
when the pointer is located on the one of the plurality of determination lines before the drag operation releases the first window, displaying a guide image on the display screen, the guide image indicating the determination line; and
when the pointer moves away from the one of the plurality of determination lines before the drag operation release the first window, stopping the displaying of the guide image.

19. The non-transitory computer readable medium according to claim 15, the process further comprising:
when the first window is placed on the one of the plurality of determination lines, determining whether the second window and the third window is adjacent to each other; and
when the second window and the third window is adjacent to each other, determining a size and a location of the second window and the third window so as to display the second window and the third window in the non-overlapping manner with respect to the first window according to the layout.
